(19) United States
(12) Patent Application Publication
(10) Pub. No.: US 2005/0121838 A1
(43) Pub. Date: Jun. 9, 2005

(54) Method of microembossing

(76) Inventors: Donald J. Davis, Conneaut Lake, PA (US); Ronald Sieloff, Chardon, OH (US)

Correspondence Address: Cynthia S. Murphy;RENNER, OTTO, BOISSELLE & SKLAR,LLP, Nineteenth Floor, 1621 Euclid Avenue, Cleveland, OH, 44115, US

(21) Appl. No.: 10/960,215

(22) Filed: Oct. 7, 2004

Related U.S. Application Data
(60) Provisional application No. 60/509,470, filed on Oct. 7, 2003.

(51) Int. Cl. B29C 51/00; B29C 59/00

(52) U.S. Cl. 264/553; 264/293; 264/313

(57) ABSTRACT

A method of making an article (10) having a desired microembossed architecture (18). In this method, a substrate (40) having an exterior surface (42) is sealed within a pouch (36) having an interior surface (32) with a microstructure (34) corresponding to the desired microembossed architecture (18). The pouch (36) is evacuated, whereby the microstructure (34) contacts the exterior surface (42) of the substrate (40) sealed therein. The evacuated pouch (36) is then thermally processed so that the microstructure (34) embosses at least a region of the exterior surface (42) of the substrate (40) so as to form the desired microembossed architecture (18).

### RELATED APPLICATION

This application claims priority under 35 U.S.C. §119(e) to U.S. Provisional Patent Application No. 60/509,470 filed on Oct. 7, 2003. The entire disclosure of this provisional application is hereby incorporated by reference.

### FIELD OF THE INVENTION

This invention relates generally, as indicated, to a method of microembossing and, more particularly, to a microembossing method wherein microsized architecture is formed on an article.

### BACKGROUND OF THE INVENTION

Microsized architecture refers to one or more microsized (e.g., having a dimension no greater than 1000 microns) structures arranged in a predetermined pattern on a substrate that can be, for example, a rigid or flexible sheet. Typical microsized architecture includes channels, wells, and/or recesses having depths less than the thickness of the unformed original substrate. Microembossing is commonly used to form microsized architecture and, in many applications, the use of rigid tooling to emboss this architecture has been highly effective. However, when curved articles are required and/or when two-sided embossing is necessary, such rigid tooling does not always yield satisfactory results.

### SUMMARY OF THE INVENTION

The present invention provides a microembossing method that is especially useful when microembossing an article having a curved geometry and/or when microembossing opposite surface regions (e.g., top and bottom) of an article.

More particularly, the present invention provides a method of making an article having a desired microembossed architecture. The method comprises the steps of placing a substrate having an exterior surface within a sheet having an interior surface with a microstructure corresponding to the desired microembossed architecture; evacuating the area around the sheet, whereby the microstructure will contact the exterior surface of the substrate; and thermally processing the sheet so that the microstructure embosses at least a region of the exterior surface of the substrate so as to form the desired microembossed architecture. In one embodiment of the invention, a pouch is provided which has an interior surface with a microstructure corresponding to the desired microembossed architecture, the substrate being sealed within the pouch, and the pouch being evacuated, whereby the microstructure will contact the exterior surface of the substrate sealed therein. In another embodiment of the invention, a sleeve is provided which has an interior surface with the microstructure corresponding to the desired microembossed architecture, the substrate being wrapped in the sleeve, the wrapped substrate being sealed within a pouch, and the pouch being evacuated, whereby the microstructure on the sleeve will contact the exterior surface of the substrate wrapped therein.

These and other features of the invention are fully described and particularly pointed out in the claims. The following description and drawings set forth in detail certain illustrative embodiments of the invention, which are indicative of but a few of the various ways in which the principles of the invention may be employed.

### DRAWINGS

FIG. 1 is side view of an article having a desired microembossed architecture on an exterior surface thereof.

FIGS. 1A and 1B are close-up views of microembossed architecture on two regions of the exterior surface of the article.

FIG. 1C is a close-up view of microembossed architecture on the exterior surface of a modified form of the article.

FIG. 2 is a schematic view of sheets used to form a pouch according to the microembossing method of the present invention.

FIGS. 2A and 2B are close-up views of the interior surfaces of the sheets, the interior surfaces having a microstructure corresponding to the desired microembossed architecture.

FIG. 3 is a top view of the sheets shown in FIGS. 2A and 2B after they have been joined along three edges to form a pouch with an access opening.

FIG. 4 is a schematic side view of the joined sheets with a substrate inserted through the access opening, the substrate corresponding to the shape of the article, absent the microarchitecture.

FIGS. 4A and 4B are schematic close-up views of the exterior surfaces of the substrate.

FIG. 4C is a schematic close-up view of the exterior surface of a modified form of the substrate.

FIG. 5 is a schematic side view of the pouch after the access opening has been sealed, whereby it can be evacuated.

FIG. 6 is a schematic view of the pouch after it has been evacuated.

FIG. 6A is a close-up schematic view showing the microstructure on the interior surfaces of the pouch contacting the exterior surfaces of the substrate.

FIG. 7 is a schematic side view of the sealed, evacuated pouch being heated.

FIG. 8 is a schematic side view of the sealed, evacuated pouch being cooled.

FIG. 9 is a schematic side view of the pouch being opened and the microembossed article being removed.

FIG. 10 is a schematic side view of a sheet used to form an interior sleeve according to another microembossing method of the present invention.

FIG. 10A is a schematic close-up view of a surface of the sheet, the sheet having a microstructure corresponding to the desired microembossed architecture.

FIG. 11 is a schematic side view of a substrate placed on the sheet adjacent to the surface containing the microstructure.

FIG. 12 is a schematic side view of the sheet wrapped around the substrate to form a sleeve.

FIG. 13 is a schematic side view of the wrapped substrate inside a sealed pouch.

FIG. 14 is a schematic side view of the pouch after it has been evacuated.

FIGS. 14A and 14B are close-up schematic views showing the microstructure on the interior surface of the sleeve contacting the exterior surfaces of the substrate.

FIG. 15 is a side schematic view similar to FIG. 13 with a modified form of a pouch.

FIG. 16 is a side schematic view similar to FIG. 13 with a bladder being provided inside the pouch.

FIG. 17 is a side schematic view similar to FIG. 13 with a pressurizing chamber also being provided.

### DETAILED DESCRIPTION

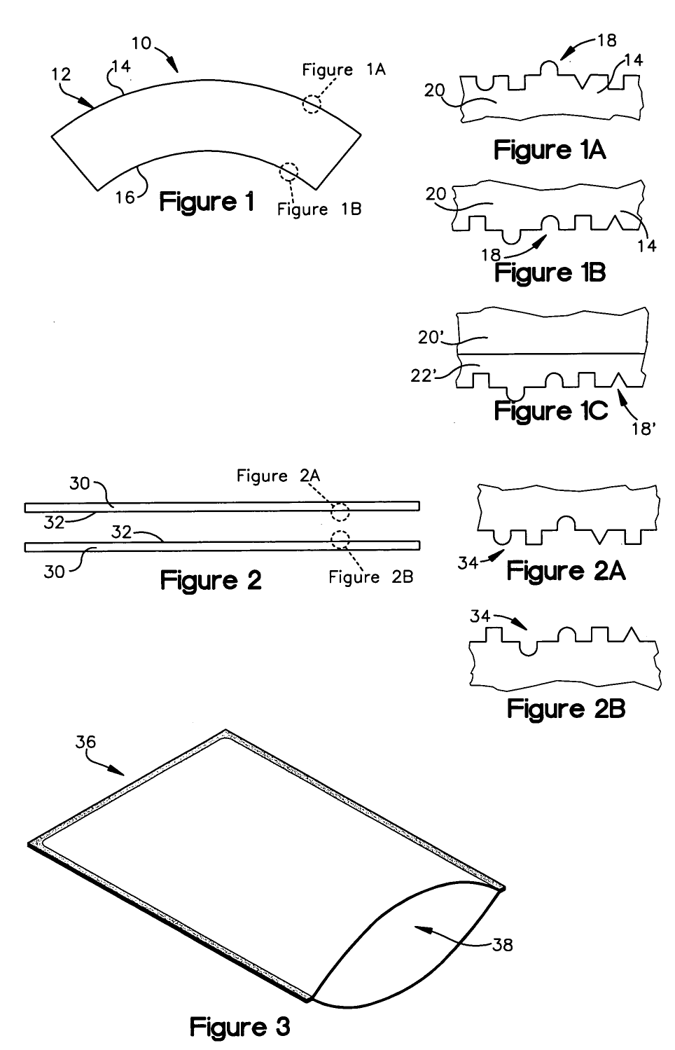

Referring now to the drawings in detail, and initially to FIG. 1, an article 10 made by the microembossing method of the present invention is shown. The article 10 has an exterior surface 12 and, in the illustrated embodiment, the article 10 has a curved (i.e., non-flat) geometry and thus its exterior surface 12 has curved regions, namely a top region 14 and a bottom region 16. As explained in more detail below, the present invention may be especially useful when microembossing articles having such curved geometries. As is also explained in more detail below, the present invention additionally or alternatively may be especially useful when microembossing opposite surface regions (e.g., top and bottom) of an article.

As shown in FIGS. 1A and 1B, the top surface region 14 and the bottom surface region 16 each have a desired microembossed architecture 18. The microembossed architecture 18 can include, for example, channels, wells, and/or recesses having depths less than the thickness of the article 10. Typically, such microsized architecture will have at least one dimension (e.g., length, height, and/or width) of less than 1000 microns.

In the embodiment shown in FIGS. 1, 1A and 1B, the article 10 comprises a main body 20 of an embossable material, and the architecture is embossed therein. In a modified form shown in FIG. 1C, the article 10′ comprises a main body 20′ of a not necessarily embossable material and a coating 22′ of embossable material in which the architecture 18′ is embossed.

Referring now to FIGS. 2-9, the elements and steps of the preferred microembossing method of the present invention are schematically shown. In FIG. 2, two sheets 30 are shown which are used to form a pouch (namely pouch 36, introduced below). The sheets 30 have interior surfaces 32 and, as shown in FIGS. 2 and 2B, the interior surfaces 32 include a microstructure 34 corresponding to (e.g., the negative of) the desired microembossed architecture 18. The microstructure 34 on the respective sheets 30 can be the same or different, depending upon the desired architecture 18 for the respective surface regions 14 and 16 on the article 10.

As explained in more detail below, the sheets 30 must be made of a flexible material to allow contraction during the evacuation steps. The material selection for the sheets 30 will be, to some degree, dictated by thermal processing requirements. Specifically, for example, the sheets 30 should have a glass transition temperature higher than that used during thermal processing steps so that the microstructure 34 maintains its integrity during embossing steps. Possible material candidates for the sheets 30 include, but are not limited to, polyester, such as a nylon film. That being said, any film material, thermoplastic, thermosetting or otherwise, compatible with the manufacturing method, is contemplated by the present invention.

The microstructure 34 can be formed on the interior surfaces 32 of the sheets 30 by microreplication such as, for example, stamping by a master tool. The master tool can be made in a conventional manner, such as ruling, diamond turning, photolithography, deep reaction ion etching, plasma etching, reactive ion etching, deep x-ray lithography, electron beam lithography, ion milling, or combinations thereof.

In the illustrated embodiment, the sheets 30 are rectangular in shape and, as is shown in FIG. 3, they can be joined together along three edges to form a pouch 36 having an access opening 38. The joining can be accomplished by adhesives, welding, or any other seaming method which results in an air tight seal. It may also be noted that the sheets 30 need not be rectangular, as they can be any other polygonal, non-polygonal, circular, regular or irregular shape.

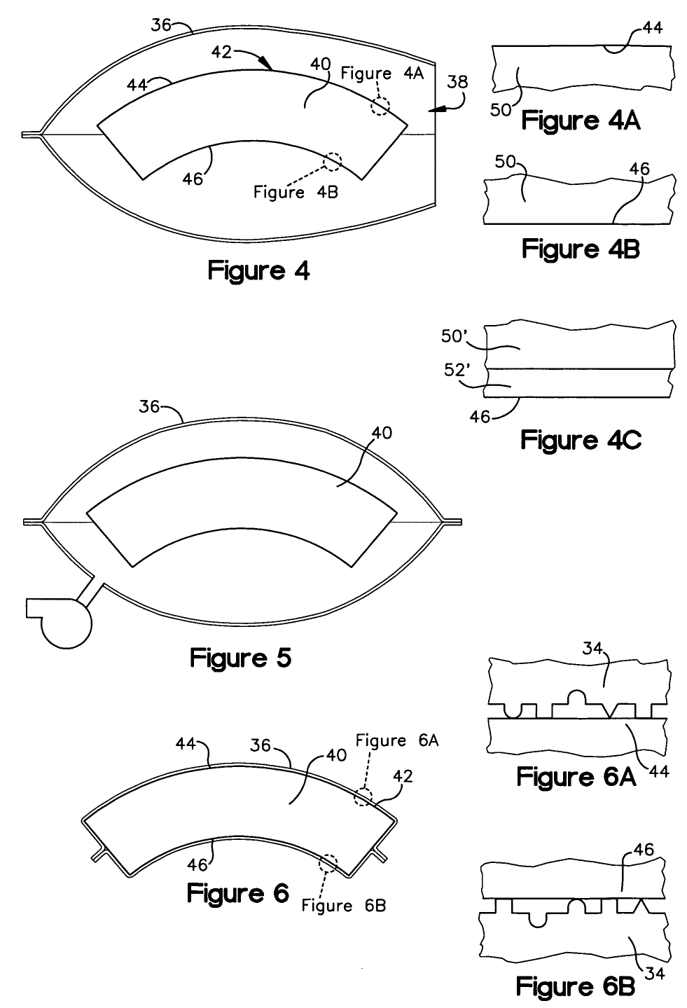

As shown in FIG. 4, a substrate 40 is placed inside the pouch 36 (via the access opening 38 in the illustrated embodiment). The substrate 40 has an exterior surface 42 and an overall geometry corresponding to the geometry of the article 10. Thus, the substrate 40 has a curved (i.e., non-flat) geometry and, thus, its exterior surface 42 has curved regions, namely a top region 44 and a bottom region 46. As is shown in FIGS. 4A and 4B, at this stage in the method, the surface regions 44 and 46 have a smooth “non-embossed” profile.

To produce the article 10 shown in FIGS. 1, 1A and 1B, the substrate 40 comprises a main body portion 50 formed of an embossable material, as is shown in FIGS. 4A and 4B. To produce the modified article 10′ shown in FIG. 1C, a modified substrate 40′ shown in FIG. 4C is used. This substrate 40′ comprises a main body 50′ of a not necessarily embossable material and a coating 52′ of embossable material. In either case, the embossable material can comprise a thermoplastic material, such as polyolefins, both linear and branched, polyamides, polystyrenes, polyurethanes, polysulfones, polyvinyl chloride, polycarbonates, and acrylic polymer and copolymer. In one embodiment, the thermoplastic material includes at least one filler, such as, for example, silicates. In any event, it is important that the embossable material of the substrate 40 have a glass transition temperature lower than the glass transition temperature of the material used to make the pouch 36.

As shown in FIG. 5, the pouch 36 is sealed in the illustrated embodiment by joining the fourth edges of the respective sheets 30 previously defining the access opening 38, as is shown in FIG. 5. It may be noted at this point that the steps shown schematically in FIGS. 2-5 simply illustrate one way of sealing the substrate 40 within the pouch 36 so that the pouch 36 can be evacuated. Other ways and means of accomplishing this result are certainly possible with, and contemplated by, the present invention. For example, the pouch 36 can be formed in one piece and/or formed around the substrate 40. Also, the evacuation step discussed below can be performed after such sealing step, during such sealing step, and/or prior to such sealing step.

As shown in FIG. 6, the sealed pouch 36 is then evacuated, whereby its interior surfaces 32 contract inwardly and its microstructure 34 contacts the exterior surface 42 of the substrate 40. The level of evacuation is sufficient (upon subsequent thermal processing steps) to cause embossing of the surface 42 of the substrate. It may be noted that the contraction of the pouch 36 allows the “mold” to transform shape to accommodate the geometry of the substrate 40, making the present invention especially useful when microembossing articles having curved geometries. It may also be noted that the encompassing nature of the contracting pouch 36 allows the simultaneous embossing of both the top region 44 and the bottom region 46, making the present invention especially useful when microembossing opposite surface regions (e.g., top and bottom) of an article.

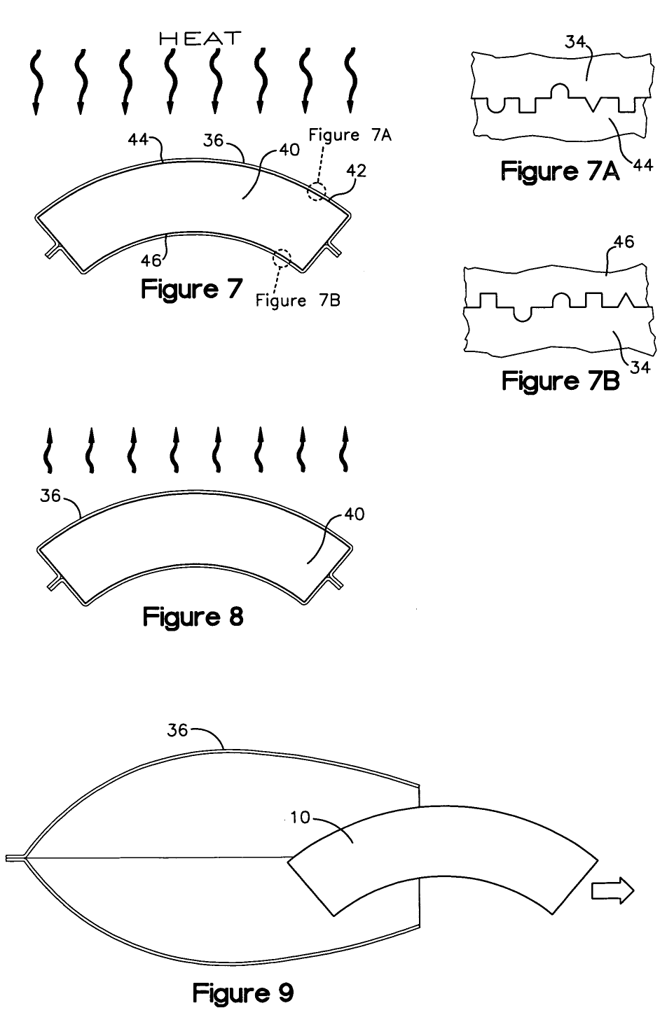

As shown in FIGS. 7 and 8, the pouch 36 (with substrate 40 sealed therein) is then thermally processed so that the microstructure 34 embosses the exterior surface 42 of the substrate to form the desired microembossed architecture 18. The thermal processing step can comprise heating the evacuated pouch 36 by, for example, placing it in a oven, flowing forced air over it, and/or supplying an IR light source (FIG. 7). The temperatures used during such a heating step will depend upon the material make-up of the pouch 36 and/or the substrate 40. For example, the processing temperature could be designed to be just above the glass transition temperature of the embossable material of the substrate 40 which, as discussed above, would preferably be well below the glass transition temperature of the pouch 36. The thermal processing step can also comprise a subsequent cooling step (FIG. 8).

After completion of the thermal processing steps, the pouch 36 can be opened (e.g., by severing a seam and/or a sheet) and the substrate 40, now the article 10, removed. Preferably, the pouch 36 is designed so that one-time uses are economical, whereby the pouch 36 can be discarded.

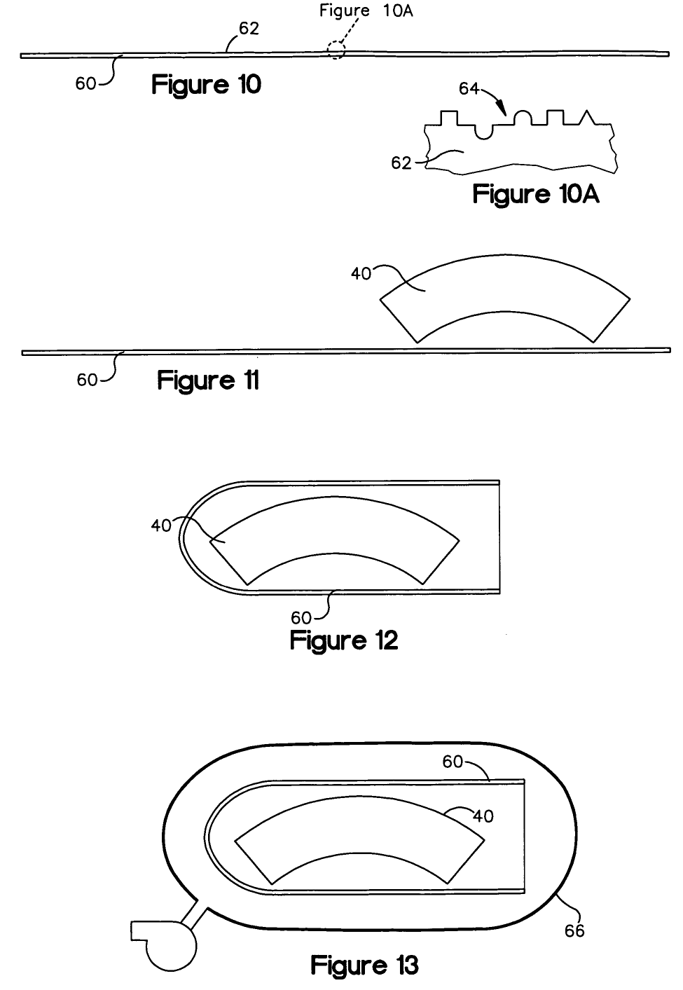

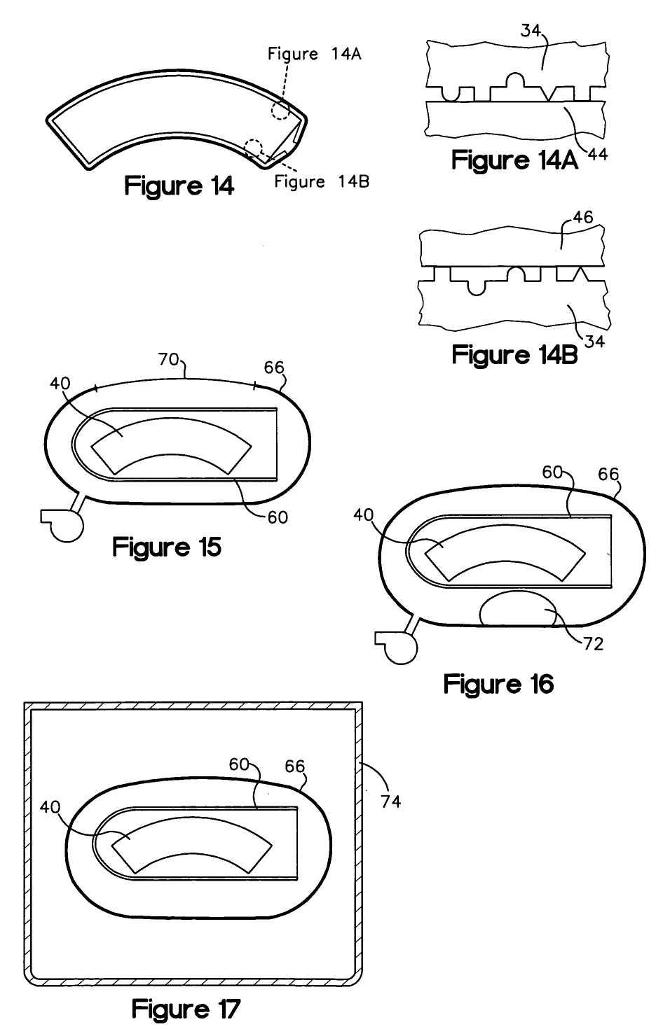

Referring now to FIGS. 10-14, the elements and steps of another preferred microembossing method according to the present invention are schematically shown. As shown in FIG. 10, a single sheet 60 is used in this method, the sheet 60 having a surface 62 which includes a microstructure 64 (FIG. 10A) corresponding to the desired architecture 18. The material selection and/or microstructuring method can be the same as those used with the sheets 30 discussed above. As shown in FIGS. 11 and 12, the sheet 60 is wrapped around the substrate 40.

The wrapped substrate 40 is then sealed inside a pouch 66, which is then evacuated, whereby the sheet's interior surface 62 contracts inwardly and its microstructure 64 contacts the exterior surface 42 of the substrate 40. Again, the contraction of the pouch 66 allows the “mold” to transform its shape to accommodate the geometry of the substrate 40, making the present invention especially useful when microembossing articles having curved geometries. Also, the encompassing nature of the contracting pouch 66 allows the simultaneous embossing of both the top region 44 and the bottom region 46 of the substrate 40, making the present invention especially useful when microembossing opposite surface regions (e.g., top and bottom) of an article. After the evacuation step, heating, cooling, and removing steps are performed as discussed above to complete the microembossing process.

Referring now to FIG. 15, the pouch 66 can be modified to include a shrinking section 70 aligned with the convex region (e.g., the top region 44 in the illustrated embodiment) of the substrate 40. The section 70 can be made of shrink film or another appropriate material. In any event, the shrinkage of this section 70 during evacuation and/or thermal processing can help to eliminate wrinkles, provide more uniform pressure, and/or create more pressure by tightening up the contacting section of the pouch 66.

Referring now to FIG. 16, a bladder 72 (or other suitable component) can be aligned with the concave region (e.g., the lower region 46 in the illustrated embodiment) of the substrate 40. As the pouch 66 contracts, it will push the bladder 72 into the concave region thereby ensuring tight engagement of the sleeve 60 with the substrate 40. It may be noted that another bladder (having an appropriate shape) could be aligned with the convex region (e.g., the upper region 44 in the illustrated embodiment) of the substrate 40. Additionally or alternatively, the bladder 72 could be used in combination with the shrink section 70 discussed above. A further option is to place bladders outside of the pouch 66 which expand upon evacuation to insure tight engagement of the sleeve 60 with the substrate 40. The bladder can contain a gas or a liquid, and could be a sealed unit or connected to a pumping device which could inflate and deflate the bladder as required.

Referring now to FIG. 17, the pouch 66 is shown within a pressurizing chamber 74. With such a chamber 74, a fluid is used to apply pressure to the contracting pouch 66 as evacuation occurs. The fluid is preferably a liquid, such as water, and applies supplemental external pressure during and after evacuation to enhance the embossing procedure. Such external pressure could be applied instead by, for example, a mechanical press, foam rollers or other suitable pressure-applying components.

Although the invention has been shown and described with respect to certain preferred embodiments, it is evident that equivalent and obvious alterations and modifications will occur to others skilled in the art upon the reading and understanding of this specification. The present invention includes all such alterations and modifications and is limited only by the scope of the following claims.

1. A method of making an article having a desired microembossed architecture, said method comprising the steps of:
placing a substrate having an exterior surface within a sheet having an interior surface with a microstructure corresponding to the desired microembossed architecture;
evacuating the area around the sheet, whereby the microstructure will contact the exterior surface of the substrate; and
thermally processing the sheet so that the microstructure embosses at least a region of the exterior surface of the substrate so as to form the desired microembossed architecture.

2. A method as set forth in claim 1, wherein said sealing step is performed prior to said evacuating step.

3. A method as set forth in claim 1, wherein said thermal processing step comprises heating.

4. A method as set forth in claim 3, wherein said heating step is accomplished by an oven, a flow of forced air, or an IR light source.

5. A method as set forth in claim 3, wherein said thermal processing step comprises cooling after said heating step.

6. A method as set forth in claim 1, wherein the embossed region of the substrate is a curved region of the exterior surface of the substrate.

7. A method as set forth in claim 6, wherein the curved region is on the upper side or the lower side of the substrate.

8. A method as set forth in claim 1, wherein the substrate includes another region that is also embossed during said thermal processing step.

9. A method as set forth in claim 1, wherein the substrate comprises an embossable material that is embossed by the microstructure, wherein the embossable material has a glass transition temperature, and wherein the sheet having the microstructure is made of material having a glass transition temperature higher than the glass transition temperature of the embossable material of the substrate.

10. A method as set forth in claim 9, wherein the substrate comprises a main body and wherein the main body is made of the embossable material.

11. A method as set forth in claim 9, wherein the substrate comprises a main body and a coating, wherein the coating is made of the embossable material.

12. A method as set forth in claim 1, wherein said placement and evacuation steps comprise providing a pouch having an interior surface with a microstructure corresponding to the desired microembossed architecture, sealing the substrate within the pouch, and then evacuating the pouch, whereby the microstructure will contact the exterior surface of the substrate sealed therein.

13. A method as set forth in claim 1, wherein said placement and evacuation steps comprise providing a sleeve having an interior surface with a microstructure corresponding to the desired microembossed architecture, wrapping the substrate in the sleeve, sealing the wrapped substrate within a pouch, and evacuating the pouch, whereby the microstructure on the sleeve will contact the exterior surface of the substrate wrapped therein.

14. A method as set forth in claim 13, wherein the pouch includes a shrinkable section which shrinks during evacuation and/or thermal processing.

15. A method as set forth in claim 14, wherein the shrinkable section is aligned with a convex region of the substrate.

16. A method as set forth in claim 13, wherein a bladder is aligned with a region of the substrate so that, as the pouch contracts, it will push the bladder into that region of the substrate thereby ensuring tight engagement of the sleeve with the substrate.

17. A method as set forth in claim 16, wherein the bladder is aligned with a concave region of the substrate.

18. A method as set forth in claim 13, wherein the pouch is evacuated within a pressure chamber whereby external pressure is applied to the sleeve during and after evacuation.

19. A method as set forth in claim 18, wherein the pressure chamber contains a liquid.

20. A method as set forth in claim 19, wherein the liquid is water.
